(19) United States
(12) Patent Application Publication
(10) Pub. No.: US 2014/0265313 A1
(43) Pub. Date: Sep. 18, 2014

(54) INSTRUMENT PORT ATTACHMENT ADAPTER

(71) Applicant: Boston Scientific Scimed, Inc., Maple Grove, MN (US)

(72) Inventors: Bernadette DURR, Marlborough, MA (US); Molly PHILLIPS-HUNGERFORD, Somerville, MA (US); Andrew WHITNEY, Douglas, MA (US); Farah KHAN, West Greenwich, RI (US); Chris BENNING, Lowell, MA (US)

(73) Assignee: Boston Scientific Scimed, Inc., Maple Grove, MN (US)

(21) Appl. No.: 14/204,256

(22) Filed: Mar. 11, 2014

Related U.S. Application Data
(60) Provisional application No. 61/780,327, filed on Mar. 13, 2013.

(51) Int. Cl. F16L 37/12

(52) U.S. Cl. CPC F16L 37/12
USPC 285/305

(57) ABSTRACT

Adapters for attaching a device to a port and methods of use thereof are disclosed. The adapter may include a housing to receive the device, wherein the housing includes an inner cavity configured to receive the port, and a sealing member; and an engaging member coupled to and moveable relative to the housing, the engaging member configured to move between a first position and a second position, where in the first position the engaging member locks the housing to the port, and in the second position the engaging member unlocks the housing from the port.

### CROSS-REFERENCE TO RELATED APPLICATIONS

This application claims the benefit of priority of U.S. Provisional Application No. 61/780,327, filed on Mar. 13, 2013, the entirety of which is incorporated by reference herein.

### FIELD OF THE DISCLOSURE

Embodiments of the present disclosure generally relate to medical devices and methods of use thereof. In particular, embodiments of the present disclosure relate to adapters for attaching a medical device to a port of a channel, for performing a medical procedure with the medical device.

### BACKGROUND OF THE DISCLOSURE

Medical procedures often require the use of a scoping instrument to collect data such as images or samples, or to treat an area of interest in a patient's body. For example, a scoping instrument (e.g., an endoscope, colonoscope, ureteroscope, or bronchoscope, among others) may be delivered through a small body incision or a natural body orifice to reach the area of interest. The scoping instrument may include one or more ports for accepting a medical device to perform various procedures such as tissue excision, sampling, and/or other diagnostic and surgical work. In some cases, however, the medical device may not be compatible with the scoping instrument, for example if the medical device and the scoping instrument have different connection mechanisms.

Bronchoscopes, for example, are widely used in transbronchial biopsy (TBB). TBB is a medical procedure that uses special biopsy forceps designed to be used in the lungs of a patient's body. During TBB, these biopsy forceps are used to retrieve a small piece of tissue from a suspicious area of the lung or the airway. The retrieved sample of tissue is then examined for diagnosis, e.g., determination of a lung disease such as lung cancer. In such procedures, a thin flexible bronchoscope is generally inserted via a patient's mouth into the lungs of the patient's body. Bronchoscopes have been widely used for diagnosing lung cancer and other lung related diseases. During their application, bronchoscopes may be inserted through the mouth or nose of a patient, into an airway within the patient's body to diagnose various lung diseases. Among the different bronchoscopic procedures, Transbronchial Needle Aspiration (TBNA) is a minimally-invasive technique that allows a bronchoscopist to collect samples of tissue from beyond the confines of the endobronchial tree, for example, enlarged lymph nodes, extrinsic compression, certain sub-mucosal lesions, etc. TBNA may be performed to stage lung cancer by sampling mediastinal nodal stations, and to diagnose other causes of mediastinal adenopathy. During this procedure, a TBNA device is generally attached to the bronschoscope via a biopsy port.

Endobronchial Ultrasonography (EBUS) is a diagnostic modality by which a miniature ultrasonic probe is introduced to the bronchial (tracheal) lumen, providing tomographic images of the bronchial (tracheal) tissue. EBUS is used for determination of position and shape of the bronchial structure, particularly lymph nodes, during TBNA. This procedure can access tumor invasion into a bronchus and achieve depth of penetration into surrounding tissue, and is useful in guiding biopsies of peripheral lung lesions through the accessory channel of an EBUS.

Structural differences in the different kinds of conventionally manufactured bronchoscopes require different kinds of fitting mechanisms, such as through adapters, to connect a TBNA device to a biopsy channel. For example, three EBUS scope manufacturers, e.g., Pentax, Fujinon, and Olympus, may use different connections. A Pentax bronchoscope generally has a standard luer fitting, which facilitates direct connection of the TBNA device to the biopsy channel. On the other hand, an Olympus or a Fujinon scope generally includes a flange-style biopsy port, which requires the TBNA device to have a more complicated locking connection to fit over the biopsy channel. Effectively, the difference in geometry of the scopes makes it challenging for the same TBNA device to be compatible with different designs of scopes, without the need of an adapter for attachment. Further, existing adapters for attaching a TBNA device to a biopsy port do not allow for one-handed use, nor attachment of the TBNA device to the adapter prior to being inserted into the biopsy channel.

Therefore, considering the problems mentioned above, there exists a need for a mechanism for introducing a medical device into an instrument port that is compatible with different types of connection mechanisms.

### SUMMARY OF THE DISCLOSURE

Embodiments of the present disclosure provide a mechanism for attaching a medical device to a port of an instrument channel.

The present disclosure includes an adapter for attaching a device to a port, the adapter comprising a housing to receive the device, wherein the housing includes an inner cavity configured to receive the port, and a sealing member; and an engaging member coupled to and movable relative to the housing, the engaging member configured to move between a first position and a second position, wherein in the first position, the engaging member engages the housing to the port, and in the second position the engaging member unlocks the housing from the port. Embodiments of the present disclosure may include one or more of the following features: the engaging member may comprise a sliding member configured to slide within a slot in the housing between the first position and the second position; the engaging member may include at least one protrusion and the slot of the housing may include at least one groove for receiving the at least one protrusion; or the slot of the housing may include at least one protrusion and the engaging member may include at least one groove for receiving the at least one protrusion; a proximal end of the housing may include a locking mechanism configured to receive and lock the device to the housing; the engaging member may include a resilient member; the resilient member may include a spring, and compression of the spring may align an opening of the engaging member with a portion of the housing and with the port; the engaging member may be configured to fit under a flange of the port to lock the housing to the port; the locking mechanism may include a luer-lock fitting or a threaded fitting; the housing may include a lumen configured to receive the device and substantially align the device with a channel of the port; or the sealing member may include a flexible material configured to seal the device to the port.

The present disclosure further includes an adapter for attaching a device to a port, the adapter comprising a housing core to receive the device, wherein the housing core includes an inner cavity configured to receive the port, a sealing member, and a plurality of arms configured to surround and engage the port; and an engaging member coupled to and movable relative to the housing core, the engaging member configured to move between a first position and a second position, wherein in the first position, the engaging member locks the housing core to the port, and in the second position the engaging member unlocks the housing core from the port. Embodiments of the present disclosure may include one or more of the following features: the engaging member may include a collar configured to rotate and lock the housing core to the port; the housing core may include at least one protrusion and the collar may include a slot configured to receive the at least one protrusion; a proximal end of the housing may include a locking mechanism configured to receive and lock the device to the housing; the at least one protrusion may be configured to slide along a horizontal basal portion of the slot in response to rotation of the collar; a distal end of the housing core may have an outer diameter greater than an outer diameter of a proximal end of the housing core; or rotation of the collar may push the plurality of arms radially inwards to lock the housing core to the port.

The present disclosure further includes a method of introducing a device into a port, the method comprising attaching an adapter to the port, where the adapter includes a housing to receive the device, and an engaging member coupled to and moveable relative to the housing, the engaging member configured to move between a first position and a second position, wherein in the first position the engaging member locks the housing to the port, and in the second position the engaging member unlocks the housing from the port; the method further including moving the engaging member from the second position to the first position to lock the housing to the port, and introducing the device into a proximal portion of the housing. Embodiments of the present disclosure may include one or more of the following features: the engaging member may comprise a sliding member configured to slide within a slot in the housing between the first position and the second position; or the engaging member may comprise a collar that surrounds the housing, wherein moving the engaging member from the second position to the first position includes rotating the collar.

Additional objects and advantages of the described embodiments will be set forth in part in the description that follows, and in part will be apparent from the description, or, may be learned by practicing the disclosure. The objects and/or advantages of the disclosure will be realized and attained by way of the elements and combinations particularly pointed out in the appended claims.

It is to be understood that both the foregoing general description and the following detailed description are exemplary and explanatory only, and are not restrictive of the described embodiments, as claimed.

### BRIEF DESCRIPTION OF THE DRAWINGS

The accompanying drawings, which are incorporated in, and constitute a part of this specification, illustrate exemplary embodiments of the present disclosure and, together with the description, serve to explain the principles of the disclosure.

FIG. 1A is a cross-sectional view of an adapter for attaching a medical device to an instrument port, in accordance with an embodiment of the present disclosure.

FIGS. 1B and 1C illustrate top views of the adapter of FIG. 1, depicting the adapter in a locked and unlocked configuration, respectively, according to the present disclosure.

FIGS. 2A and 2B are top views of an adapter for attaching a medical device to an instrument port, in accordance with another embodiment of the disclosure.

FIGS. 3A and 3B show a cross-sectional view and a top view, respectively, of an adapter for attaching a medical device to an instrument port, according to another embodiment of the present disclosure.

FIGS. 4A-4C show different perspective views of an adapter for attaching a medical device to an instrument port, depicting the adapter in different configurations.

FIGS. 5A and 5B are perspective views of components of an adapter for attaching a medical device to an instrument port, according to another embodiment of the present disclosure.

FIG. 5C illustrates a perspective assembled view of the adapter depicted in FIGS. 5A and 5B.

FIG. 6 shows a cross-sectional view an adapter, according to another embodiment of the present disclosure.

FIG. 7 shows an adapter with a collar including a pivot button, according to another embodiment of the present disclosure.

### DESCRIPTION

Reference will now be made in detail to embodiments of the present disclosure, examples of which are illustrated in the accompanying drawings. Wherever possible, the same reference numbers will be used throughout the drawings to refer to the same or like parts.

Embodiments of the present disclosure may relate to devices used in medical procedures. In particular, embodiments of the present disclosure may be useful in compatibly introducing a medical device into a port of an instrument channel.

The present disclosure provides adapters including a mechanism for attaching a device to a port leading into a channel compatible with different kinds of instruments. For example, embodiments of the present disclosure may allow a medical device to be attached via both a luer fitting (e.g., used by a standard Pentax scope) and a flange style port (e.g., used by an Olympus or Fujinon scope). Further, the mechanisms may completely seal the port when the device is attached to the scope to keep the port airtight, for example, when suction is applied. This may avoid contamination of blood in collected samples. Some embodiments of the present disclosure allow a user to orient the medical device in a preferred position.

FIG. 1A is a cross-sectional view of an adapter 100 for attaching a medical device to a port leading into an instrument channel, according to an embodiment of the present disclosure. As shown, the adapter 100 may include a housing 105 configured to be mounted over the top of a port 110. The housing 105 has a proximal portion 102 to which a medical device (not shown) may be attached and locked with respect to the port 110 through a suitable locking mechanism 170. A distal portion 104 of the housing 105 may engage the port 110. Wherever mentioned in the present disclosure, the term “distal” refers to a direction farthest away from a user of a device, and “proximal” refers to a direction opposite to the distal direction, i.e., towards the user.

While engaging the port 110, the housing 105 may be positioned over, and may align symmetrically with, the port 110 such that a proximal portion 112 of the port 110 may be received into the housing 105. Specifically, the housing 105 may include an inner cavity to receive the port 110 and allow engagement of the housing 105 to the port 110. An outer wall 115 of the housing 105 may surround the port 110 when the housing 105 is positioned over the port 110. In some embodiments, the housing 105 may have a generally cylindrical shape suitable for surrounding the port. However, other suitable shapes for the housing 105 may also be contemplated and suitable for surrounding a port, such as, e.g., rectangular, elliptical, or other regular or irregular shapes.

An engaging member 125 may be disposed within the outer wall 115 of the housing 105 via a slot 130 within the outer wall 115. Different shapes and structural designs for the engaging member 125 may be contemplated, examples of which are provided in conjunction with subsequent figures of the disclosure. Further, the engaging member 125 may be configured to slide laterally, e.g., back and forth, through the slot 130 in the housing 105 as indicated by the directional arrow 135 shown in FIG. 1A.

FIG. 1A shows the engaging member 125 at a first position, wherein the housing 105 is unlocked from the port 110. As shown, at least a portion of the engaging member 125 may reside underneath a flange 182 of a proximal portion 112 of the port 110, and may keep the housing 105 fixedly positioned and secured over the top of the port 110. Further, the outer wall 115 of the housing 105 is in contact with a shoulder 145 of the port 110. The shoulder 145 may be integral with the port 110, and may extend circumferentially around the port 110, and thus, the channel 120.

A sealing member 165 may be provided within the housing 105 and configured to fit over the proximal portion 112 of the port 110. For example, in some embodiments, the sealing member 165 maintains an airtight seal between a medical device inserted into the adapter 100 and the channel 120 within the port 110. For example, the sealing member 165 may be configured to maintain an airtight seal when suction is applied, e.g., to prevent substantial blood contamination of a tissue sample. The sealing member 165 may have a shape compatible with the top of port 110, e.g., fitting securely over the flange 182 of the port 110 to create a seal. In some embodiments, the sealing member 165 and the top of the port 110 may both have a generally circular cross-section. Other alternative shapes may also serve the purpose of the sealing member 165, for example, based on the cross-sectional shape of the port 110.

Any appropriate material may constitute the sealing member 165, including, for example, natural or synthetic rubber. Other materials, including flexible materials, suitable for creating a seal may be used. The sealing member 165 may include a slit or other opening to allow passage of the device through the housing and into the port. In some embodiments, for example, the sealing member 165 includes a small elastomeric aperture for receiving the device. A flexible material of the sealing member 165 therefore may flex radially outward when the device is introduced into the elastomeric aperture.

An appropriate locking mechanism 170 may be provided at the proximal portion 102 of the housing 105. The locking mechanism 170 may be configured to receive and lock a device, e.g., a TBNA device, with respect to the port 110, thus fitting the device over the port securely. In some embodiments, for example, the locking mechanism 170 may include a standard luer-lock fitting or a threaded coupling. Other suitable alternative locking mechanisms may also be contemplated. The locking mechanism 170 may include a lumen 172, which may substantially align with the channel 120 of the port 110. The sealing member 165 may be attached to a distal end of the lumen 172, as shown in FIG. 1A. When the housing 105 engages the port 110, the sealing member 165 may position directly over the top of the port 110, and seal the port 110. A portion of the sealing member is visible in FIGS. 1B and 1C, interior to the flange 182 of the port 110.

To unlock the housing 105 and to release it from the port 110, the engaging member 125 may be moved laterally or radially outwards to a second position through the slot 130 within the housing 105. The engaging member 125 may include at least one protrusion 155 provided therein, and as the engaging member 125 is moved to the second position, the protrusion 155 may vertically align with an opening or groove within the slot 130 of the housing to secure the housing 105 to the port 110. Further, once the protrusion 155 in the engaging member 125 comes out of alignment with the corresponding groove in the slot 130, e.g., via lateral movement of the engaging member 125, the housing 105 may release from the port 110.

FIG. 1B is an assembled top view of the adapter 100 of FIG. 1A, for attaching the medical device to the port, and is disposed in a configuration where the adapter 100 is locked to the port 110, thus constituting an engaged or first position. The engaging member 125 may move from a disengaged or unlocked position, shown in FIG. 1C, to establish a locked or engaged position. This movement is illustrated in FIGS. 1C and 1B by sliding the engaging member 125 from top (see FIG. 1C) to bottom (see FIG. 1B). The housing 105 thus engages the port 110, and effectively the adapter 100 is secured to the port 110.

Correspondingly, FIG. 1C shows an assembled top view of the adapter 100 of FIG. 1A where the housing 105 surrounds and engages the port 110. More particularly, FIG. 1C shows the engaging member 125 in a disengaged or second position, where the adapter 100 may be disengaged from the port 110, and thus, released from the proximal portion of the port 110. As mentioned above, to engage the adapter 100 with the port 110, the engaging member 125 may be moved to the first position, where it may reside underneath the flange of the port 110 to secure the housing 105 to the port 110.

FIGS. 2A and 2B show top views of another exemplary adapter 200 for attaching a medical device to a port, according to another embodiment of the present disclosure. The adapter 200 may have a housing 205 configured to fit over and engage a top portion of a port 210. An engaging member 225, which may be a sliding member, may be configured to slide between a first position (shown in FIG. 2A), where it fits underneath a flange (not shown) of the port 210 and locks the housing 205 to the port 210, and a second position (shown in FIG. 2B), where the housing can be released and disengaged from the top of the port 210. The method of securing and attaching the adapter 200 to the port 210 is substantially similar to that for adapter 100 shown in FIG. 1A, but wherein the housing 205 includes a set of side guards 275 to inhibit and/or prevent inadvertent pressing or sliding of the engaging member 225. For example, the side guards 275 may enclose and/or protect one or more edges of the engaging member 225 to avoid inadvertent release and disengagement of the housing 205 from the port 210.

FIG. 3A illustrates another exemplary adapter 300 for attaching a medical device to an instrument port 310, according to the present disclosure. The adapter 300 may include a housing 305 with a proximal portion 302 configured to receive a device to be attached to a port 310, and a distal portion 304 configured to engage the port 310. Specifically, the distal portion 304 of the housing 305 may have an inner cavity to receive the port 310 and engage the housing 305 with the port 310.

Adapter 300 in FIG. 3A includes an engaging member 325 configured to clip the housing 305 around the flange 382 of the port 310. As shown, the engaging member 325 is disposed in an opening 355 of the housing 305 and includes tabs 326 to clip the housing 305 underneath a flange 382 of the port 310. The tabs 326 may, for example, include a flexible material that allows the tabs 326 to flex. As the housing 305 is pushed downwards to align with the port 310, the clips 326 of the engaging member 325 may flex outward as shown by directional arrows 335 to allow the base of the housing 305 to pass over the flange 382 of the port 310. Once the tabs 326 clear the flange 382 of the port 310, tension may cause the tabs 326 to move radially inwards, e.g., towards their original position, to clip around the port 310 underneath the flange 382. In some embodiments, the engaging member 325 includes a section 327 extending between the tabs 326 that is configured to break away. For example, a sufficient amount of force applied to the section 327 may cause it to break and release tension between the tabs 326. Once the tabs 326 no longer lock the housing 305 to the port, the housing may be released and removed from the port 310.

A locking mechanism 370, which may be a luer lock or threaded coupling, for example, as mentioned earlier, may be provided at the proximal portion 302 (the top portion in FIG. 3A) of the housing 305. The locking mechanism 370 may be configured to receive the medical device, and to engage and secure the device to the proximal portion 302 of the housing 305. Further, as shown, the locking mechanism 370 may have a lumen 372, and a sealing member 365 may be attached to the distal end of the lumen 372. The sealing member 365 may be configured to fit over the top of, or a proximal portion 312 of the port 310, to establish a seal with the port 310, while the housing 305 engages the port 310.

FIG. 3B is a top assembled view of the adapter 300 of FIG. 3A, showing tabs 326 and section 327 extending between the tabs 326. As shown, the housing 305 engages and locks around the port 310 of the instrument channel 320 via the table 326 of the engaging member 325. FIG. 3B also shows a top view of the flange 382 and a portion of the sealing member 365 for receiving a device.

FIGS. 4A-4C depict an adapter 400 in different configurations, for attaching a medical device to an instrument port, according to another embodiment. FIGS. 4A-4C illustrate the transitioning of the adapter 400 from a disengaged or unlocked state (FIG. 4A) to an engaged or locked state (FIG. 4C) over a corresponding port. The engaging member 425 may be configured to slide laterally through a slot in the housing 405. The engaging member 425 may include a resilient member, such as spring 480, to couple the engaging member 425 to the housing 405. The resilient member may be formed of or include any appropriate material, such as an elastomeric material.

FIG. 4A shows the adapter 400 in a configuration where the housing 405 is unlocked from the port 410 of the instrument channel 420. A space 475 is present between the housing 405 and the shoulder 445 of the port 410. In the disengaged configuration, a portion of engaging member 425 (shown in contact with the flange 482 in FIG. 4A) prevents the housing 405 from aligning with the port 410, e.g., obstructs a portion of the housing 405 from aligning with the port 410.

The engaging member 425 may move back and forth through a slot or opening 455 within the housing 405 as indicated by the directional arrow 435. As the engaging member 425 slides towards the right and compresses the spring 480 as shown in FIG. 4B, the engaging member 425 no longer prevents the housing 405 from aligning and engaging with the port 410. To secure the housing 405 to the port 410, the housing 405 is pressed downwards or in a distal direction to align the sealing member 465 to the top of the port 410. As shown in FIG. 4B, moving the housing 405 downwards decreases the size of the space 475 between the housing 405 and the shoulder 445 of the port 410 in comparison to FIG. 4A. As the engaging member 425 moves distally with the housing 405, the engaging member 425 passes below the flange 482 of the port 410. In this configuration, compression on the spring 480 may be released, thus moving the engaging member 425 to the left and underneath the flange 482 to secure the housing 405 to the port 410. FIG. 4C shows the adapter 400 in a configuration where the housing 405 is engaged and secured to the port 410, and remains locked. The spring 480 may have sufficient stiffness to generate a restoring force therein in its compressed state, which may move the engaging member 425 to secure and lock the housing 405 while engaging the port 410. Further, by virtue of the stiffness of the spring 480, the inadvertent unlatching and removal of the housing 405 from the port 410 is avoided.

As discussed above, the sealing member 465 may align with the top portion of the port 410, and may establish a seal with the port 410 when the housing 405 engages the port 410. Further, other components such as, e.g., a locking mechanism 470, a corresponding lumen 472, and a corresponding distal portion 404, may be substantially similar in structure and function to the embodiments shown in FIGS. 1A and 3A.

FIGS. 5A-5C illustrate an adapter 500 for attaching a medical device to an instrument port leading into a channel according to another embodiment of the disclosure. Specifically, FIG. 5A shows a perspective view of the adapter 500 including a housing core 505, which may be configured to engage and position over the port (not shown). The core 505 may have a plurality of engagement members or arms 522 extending longitudinally. The arms 522 include lower (i.e., distal) gripping portions 522a that may be broadened with respect to a proximal end of the core 505, and may loosely fit around the port 510 when the core 505 engages the port. The arms 522 may be radially spaced apart from each other with respect to the port 510 in a released configuration of the adapter 500, and may be brought together (i.e., pushed radially inwards towards a longitudinal axis of core 505) when the core 505 is secured or locked to the port 510. In other words, the arms 522 may flex at their proximal ends to allow the distal gripping portions 522a to move inwards and lock around the port 510 (e.g., a flange of the port) upon application of a force. While FIG. 5A shows the arms 522 as being substantially rectangular, other suitable shapes for the arms 522 may also be contemplated.

The outer surface 506 of the core 505 may include a protrusion 526. The protrusion 526 may include, for example, a pin configured to fit into a cavity of a corresponding engaging member (shown in FIG. 5B) that surrounds the core 505, to secure and lock the housing when positioned over the port 510. While only one protrusion 526 is shown in FIG. 5A, it is contemplated that multiple such protrusions may be disposed over the outer surface 506 of the core 505, and each such protrusion may be received into a corresponding cavity or slot within the engaging member, to provide a more secure locking connection and engagement of the adapter 500 to the port 510.

A proximal or top portion of the core 505 may include a locking mechanism 524. As the housing engages the port 510, the locking mechanism 524 facilitates connection of a medical device to the core 505, for example to secure and lock the medical device to the core 505. Examples of suitable locking mechanisms 524 include a luer-lock fitting, a threaded fitting, or other mechanisms as discussed above.

FIG. 5B shows an engaging member 525 configured to surround and engage the core 505 of FIG. 5A, to secure the core 505 to the port 510 of an instrument channel. The engaging member 525 may be in the form of a collar, and may have an outer wall 532 to surround and engage the core 505. A basal portion 542 of the engaging member 525 may be configured to press the arms 522 of the core 505 radially inward to secure the core 505 around the port 510. Further, a slot 534 may be provided over the outer wall of the engaging member 525. The slot 534 may receive the protrusion 526 provided on the outer surface of the core 505 (FIG. 5A), and may retain it therein to lock the core 505 to the port. As shown, the slot 534 may have an L-shape. However, an alternatively shaped slot compatible with the shape of the protrusion 526 may also be used to receive the protrusion 526. For example, in some embodiments, the slot 534 opens distally (rather than proximally as shown in FIGS. 5A and 5B) to receive the protrusion as the engaging member 525 is moved over the core 505 from a proximal direction.

Exemplary assembly and engagement of the engaging member 525 to the core 505 is described in conjunction with FIGS. 5A and 5B. The core 505 may be mounted over the port 510, and the arms 522 may initially position radially spaced apart around the port 510. The engaging member 525 may be positioned around the core 505 from the top (i.e., proximal direction), and the protrusion 526 may be received into the slot 534 within the outer portion of the engaging member 525. In some embodiments, the protrusion 526 is compressible to allow the engaging member 525 to pass over the surface of the core 505. Once the lower (i.e., distal) portion of the engaging member 525 passes distally over the compressed protrusion 426, the slot 534 may align with the protrusion 526 such that the protrusion 526 may return to an uncompressed state and lock the core 505 to the port 510. Initially, the protrusion 526, which may be a pin and may be positioned at the left corner of the L-shaped slot 534, when the housing is disengaged from the port 510 and the engaging member 525 is in a first angular orientation with respect to the core 505. To engage and secure the core 505 to the port 510, the engaging member 525 may be moved clockwise (as viewed from the top) as indicated by the directional arrow 535, to a second angular orientation, where the protrusion 526 may shift to a right corner of the slot 534. An indentation 536 within the slot 534 may block the protrusion 526 in a smaller cavity 538 within the slot 534, and prevent movement of the protrusion 526 once it has been received into the cavity 538. By these actions, the core 505 is secured and engaged to the port 510. In this manner, the rotation of the engaging member 525 to the second angular orientation may secure the core 505 and lock it over the port of the instrument channel. It should be noted that in some embodiments, the engaging member 525 and the core 505 may be engaged before placement over the port 510. Subsequent rotation of the engaging member 525 relative to the core 505 may lock the core 505 to the port 510.

FIG. 5C shows an assembled view of the adapter 500, where the engaging member 525 substantially surrounds and engages the core 505. As shown, the protrusion 526 resides within the smaller cavity 538 of the slot 534 within the outer wall of the engaging member 525, and is retained therein, thus, securing the engaging member 525 to the core 505, and locking the core 505 to the port 510. Further, the engaging member 525 is shown in the second angular orientation, where it has rotated substantially clockwise with respect to the core 505.

In some embodiments, one or more protrusions 540 (shown in FIG. 5B) may be provided over the inner surface of the engaging member 525, which may extend radially towards the core 505 when the engaging member 525 surrounds the housing core 505. Corresponding to these protrusions, corresponding recesses or cavities (not shown) may be provided along the outer surface 506 of the core 505 to receive the protrusions. The engagement of the protrusions 540 with the corresponding recesses may provide additional stability to the adapter 500, and secure the core 505 more tightly over the instrument port 510. In other embodiments, the core 505 may include one or more protrusions that correspond with one or more recesses or cavities along the inner surface of the engaging member 525.

Here, each pair of adjacently positioned arms 522 may define a space between the corresponding pair of arms 522 in a released configuration of the adapter 500. In particular, the space may be configured to diminish in response to rotation of the engaging member 525 from the detached configuration to the locked configuration of the engaging member 525, to position the distal portions 522a of the arms 522 tightly surrounding the port 510 during engagement.

FIG. 6 shows a side view of an exemplary adapter 600, similar to that shown in FIGS. 5A-5C. The adapter 600 may include a central housing or core 605 configured to be mounted over a port 610. The core 605 may have a lower or distal portion 605b having a relatively broader cross-section compared to an upper or proximal portion 605a. The core 605 may include a plurality of engagement members or arms as mentioned above in conjunction with FIG. 5A-5C. The distal portion 605b of the core 605 may include, for example, distal gripping potions similar to 522a of FIG. 5A.

A collar 625 may act as an engaging member, and it may substantially surround and engage the core 605, to secure the core 605 over the port 610. Similar to FIGS. 5A-5C, the collar 625 may be rotated between a first position where the core 605 may engage the port 610, and a second position where it may be released and disengaged from the port 610. Since the lower portion 605b or the core 605 has a relatively broader cross-section, rotating the collar 625 compresses the core's bottom portion 605b (e.g., gripping portions) to lock the core 605 to the port 610. When the collar 625 is moved downwards, it may push the distal portion 605b (e.g., distal gripping portions) radially inwards and around the port 610, locking the core 605 to the port 610. On engagement and locking of the core 605 with the port 610, a sealing member 640 may establish a seal between a device 650 introduced through the adapter 600 via housing core 605 and into the port 610.

FIG. 7 illustrates another embodiment according to the present disclosure that includes an engaging member 725. The engaging member 725 may include a collar including a pivot button 728 configured to pivot about a pin 729. The inner portion 726 of the collar 725 may include one or more protrusions 727. The protrusions 727 may be rectangular, as shown, or may also be of any other alternative shape. Each protrusion 727 may extend radially inwards towards a corresponding housing core similar to core 505 of FIG. 5A, e.g., when the collar 725 engages and surrounds the core. The core may have one or more corresponding recesses or cavities to receive the protrusion(s), to secure the collar 725 to the core. Activation of the pin 729 (e.g., rotating the pivot button 728 about the pin 729) may cause the collar 725 to flex inwards, likewise pressing the protrusions 727 inwards to engage corresponding recesses in the core, thus locking the collar to the core and about the instrument port.

Embodiments of the present disclosure may include one or more biocompatible materials, and may include one or more rigid and/or a flexible materials. Exemplary materials include metals, polymers, alloys, composite, or the like, either in combination or alone. Other suitable material may also be contemplated without departing from the scope and spirit of the disclosure.

Embodiments of the present disclosure may be applicable to any medical or non-medical procedure. In addition, certain aspects of the aforementioned embodiments may be selectively used in collaboration, or removed, during practice, without departing from the scope of the disclosure.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. An adapter for attaching a device to a port, the adapter comprising:
a housing to receive a device, wherein the housing includes:
an inner cavity configured to receive the port; and
a sealing member; and
an engaging member coupled to and movable relative to the housing, the engaging member configured to move between a first position and a second position, wherein in the first position the engaging member locks the housing to the port, and in the second position the engaging member unlocks the housing from the port.

2. The adapter of claim 1, wherein the engaging member comprises a sliding member configured to slide within a slot in the housing between the first position and the second position.

3. The adapter of claim 2, wherein the engaging member includes at least one protrusion and the slot of the housing includes at least one groove for receiving the at least one protrusion, or wherein the slot of the housing includes at least one protrusion and the engaging member includes at least one groove for receiving the at least one protrusion.

4. The adapter of claim 2, wherein a proximal end of the housing includes a locking mechanism configured to receive and lock the device to the housing.

5. The adapter of claim 2, wherein the engaging member includes a resilient member.

6. The adapter of claim 5, wherein the resilient member includes a spring, and compression of the spring aligns an opening of the engaging member with a portion of the housing and with the port.

7. The adapter of claim 6, wherein the engaging member is configured to fit under a flange of the port to lock the housing to the port.

8. The adapter of claim 1, wherein the locking mechanism includes a luer-lock fitting or a threaded fitting.

9. The adapter of claim 1, wherein the housing includes a lumen configured to receive the device and substantially align the device with a channel of the port.

10. The adapter of claim 9, wherein the sealing member includes a flexible material configured to seal the device to the port.

11. An adapter for attaching a device to a port, the adapter comprising:
a housing core to receive the device, wherein the housing core includes:
an inner cavity configured to receive the port;
a sealing member; and
a plurality of arms configured to surround and engage the port; and
an engaging member coupled to and movable relative to the housing core, the engaging member configured to move between a first position and a second position, wherein in the first position the engaging member locks the housing core to the port, and in the second position the engaging member unlocks the housing core from the port.

12. The adapter of claim 11, wherein the engaging member includes a collar configured to rotate and lock the housing core to the port.

13. The adapter of claim 12, wherein the housing core includes at least one protrusion and the collar includes a slot configured to receive the at least one protrusion.

14. The adapter of claim 13, wherein a proximal end of the housing includes a locking mechanism configured to receive and lock the device to the housing.

15. The adapter of claim 13, wherein the at least one protrusion is configured to slide along a horizontal basal portion of the slot upon rotation of the collar.

16. The adapter of claim 11, wherein a distal end of the housing core has an outer diameter greater than an outer diameter of a proximal end of the housing core.

17. The adapter of claim 16, wherein rotation of the collar pushes the plurality of arms radially inwards to lock the housing core to the port.

18. A method of introducing a device into a port, the method comprising:
attaching an adapter to the port, wherein the adapter includes
a housing to receive the device; and
an engaging member coupled to and movable relative to the housing, the engaging member configured to move between a first position and a second position, wherein in the first position the engaging member locks the housing to the port, and in the second position the engaging member unlocks the housing from the port;
moving the engaging member from the second position to the first position to lock the housing to the port; and
introducing the device into a proximal portion of the housing.

19. The method of claim 18, wherein the engaging member comprises a sliding member configured to slide within a slot in the housing between the first position and the second position.

20. The method of claim 18, wherein the engaging member comprises a collar that surrounds the housing, and wherein moving the engaging member from the second position to the first position includes rotating the collar relative to the housing.
